(19) United States
(12) Patent Application Publication
(10) Pub. No.: US 2012/0095813 A1
(43) Pub. Date: Apr. 19, 2012

(54) LOCAL POWER GENERATION BUSINESS METHOD

(76) Inventor: Eliot Maxwell Case, Aurora, CO (US)

(21) Appl. No.: 13/305,426

(22) Filed: Nov. 28, 2011

Related U.S. Application Data
(63) Continuation-in-part of application No. 12/177,395, filed on Jul. 22, 2008, now abandoned.

(51) Int. Cl. G06Q 30/02; G06Q 50/06

(52) U.S. Cl. 705/14.1

(57) ABSTRACT

A business method to expand upon prior art methods of billing a utility customer's energy consumption from local power generation energy sources such as wind and solar systems. The invention discerns energy generated locally and energy consumed from a wide area energy source, utility or COOP. The invention allows power generated locally by leased, owned, or rented power generation equipment at the utility customer's location to be measured and billed to the customer at a separate rate than that charged by the utility to the customer. A well-engineered system will locally generate enough power to offset the utility's charges, lower the power customer's power costs and will provide revenue to the local power generation equipment provider by a power billing presented to the utility customer. The invention may utilize any power generation method such as electric, gas, oil, biomass, and or thermal.

### CROSS-REFERENCE TO RELATED APPLICATIONS

This is a Continuation-in-Part application of U.S. Ser. No. 12/177,395 filed Jul. 22, 2008, herein incorporated by reference in its entirety.

### BACKGROUND OF THE INVENTION

1. Field of the Invention

This invention relates to locally generated energy when used by a customer in common connection with energy provided by utility companies and energy cooperatives (COOP).

2. Prior Art

For many years individuals and businesses have relied upon large power utilities or utility cooperatives to provide energy in the form of electricity, natural gas, and various fossil fuels. The terms “power utility,” “Power Company” and “power cooperative” or “COOP” are generally used interchangeably in the specification in terms of technical implementation terms, with the differences between the terms being of ownership or business configuration. A COOP is usually an entity with shared ownership by the COOP's customers/members. The local small-scale generation of power by individuals is now possible by way of many environmentally friendly methods or energy efficient methods often referred to as “green power” or “renewable energy.” Green power can be generated near the utility consumer's location by means of photovoltaic cells (solar power), wind turbines for extraction of power from the passing wind (wind power), extraction of power from biomass decomposition, from thermal mass systems, efficient micro turbine and conventional generators for consumption of conventional fuels and many other present and future technologies.

To help promote the use of green power many laws have been enacted to allow utility consumers to locally generate power and place this locally generated power essentially back into the utility's system (grid). This method is often referred to as “Net Metering” and sometimes referred to as “Distributed Generation.” The power generated by these green power systems is often erratic, very high at times and nonexistent at other times. The power company provides a constant availability of power to the utility customer, which the customer pays for at a given rate per unit. When the green power source or sources are providing power for the customer's use the power is essentially free to the customer, and some excess power may be generated. At other times when no green power is generated the utility customer is reliant upon the utility for power demand. Net Metering allows the aggregate amount of locally generated green power to be subtracted directly from the power supplied by the utility by inserting the locally generated green power after the utility company's meter. This is often referred to as a “grid tied” electrical system. In Net Metering the total power generated by the local green power or other power generation source is subtracted from the power consumed from the utility. When utility power is being used the utility's power meter is rotating forward and billing the customer at the regular rate. When power is generated locally it will either reduce the amount of power consumed from the utility and thus reduce the meter's forward rotation rate or rotate the utility's meter backwards, in essence selling the power back to the utility. The utility usually only obtains a meter reading at a normal billing cycle, e.g. monthly, which is a summation of utility power used over the billing period with the power locally generated already subtracted from the metered billing to the utility. This also has the effect of smoothing out the erratic local generation peak times and times with absence of locally generated power. If the local power generated exceeds the power consumed from the utility then the utility may purchase or credit the excess power from the customer, but at a rate often as low as one third of the rate or less at which the utility normally charges the customer. Therefore, there is little incentive to locally generate more power locally than the customer uses. There is great incentive to generate power locally at a lower rate than the utility provides power.

Although green power generated locally often appears to be “free of cost”, e.g. sunlight and wind are free. A large amount of money is needed to build high efficiency solar collection and wind turbine systems and to buy and install the “Grid Tie” electronics needed to connect the locally generated power to the utility line for Net Metering. The amount of money needed to engineer and construct a green power generation facility at a home or business is often a much greater amount of capital than the customer may be able, or willing, to pay to reduce the customer's utility power bills significantly.

Relevant U.S. patents which show prior art technologies used in the background of the invention are as follows: U.S. Pat. Nos. 4,261,037, 4,399,510, 4,442,492, 4,675,828, 4,803,632, 5,237,507, 5,289,362, 5,519,622, 5,602,744, 5,729,740, 5,930,773, 5,943,656, 5,963,925, 6,035,285, 6,088,688, 6,115,698, 6,169,979, 6,343,277, 6,512,966, 6,671,585, 6,738,693, 6,785,592, 6,900,738, 6,956,500, 6,980,973, 7,043,459, 7,054,770, 7,072,858, 7,130,719, 7,133,834, 7,133,852, 7,149,727, 7,171,374, 7,301,475, 7,369,968.

### SUMMARY OF THE INVENTION

This invention pertains to a business method, using metering systems, and technological methods which allow a third party to provide the local power generation equipment by ownership, lease or rental and provide green power to the customer at a potentially lower billing rate than what the utility charges the consumer for grid power. The invention utilizes secondary power metering inserted after the conventional utility power meter. The secondary metering system measures the local power generation equipment's output. The local power generation equipment owner can then charge a rate to the power customer separate from the utility company's Net Metering charges. This invention enables a new revenue source based on secondary power metering, which promotes the use of green power, potentially provides income to green energy infrastructure investors, and can improve the environment.

### BRIEF DESCRIPTION OF THE DRAWINGS

FIG. 1 is a schematic representation of a Prior Art power system similar to what is used by an ordinary power customer.

FIG. 2a is a general schematic representation of this embodiment that is shown in detail in FIG. 2b.

FIG. 2b is a detail schematic representation of key elements added to the prior art schematic of FIG. 1 forming a detailed schematic showing the detail elements of this embodiment.

FIG. 2c is a detail schematic of the same system as FIG. 2b with the definition of ownership of equipment altered.

FIG. 3a is a detailed schematic of the system of FIG. 2b with a means of power storage and outward power metering according to an embodiment of the present invention.

FIG. 3b is a detail schematic of the system of FIG. 2c illustrating another embodiment of the invention for power storage and outward metering of power.

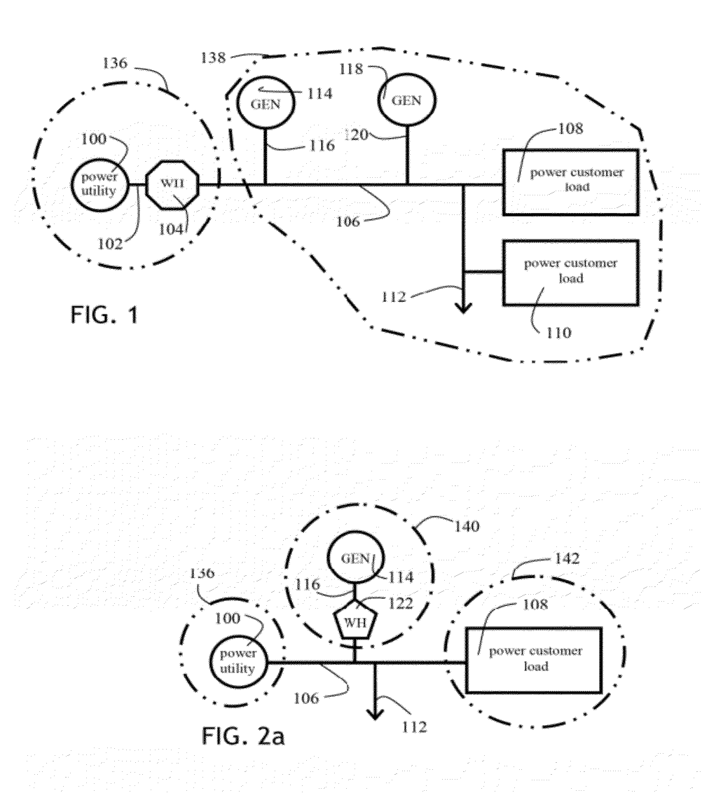

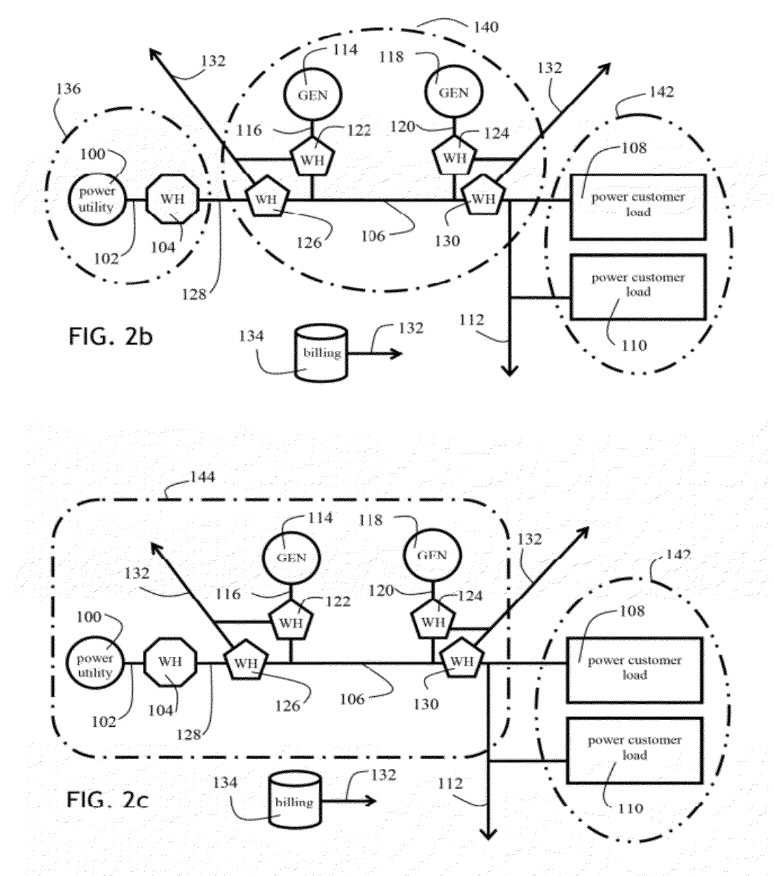

Several reference numerals are purposely the same in FIGS. 1, 2a, 2b, and 2c to show basic common elements that are presented with the same description across all four drawings for clarity.

### DRAWINGS

### Reference Numerals

100 wide area power source
102 energy feeder line
104 utility meter
106 local energy system
108 power load
110 power load
112 extension of the local energy system
114 local power generator
116 local energy feeder line
118 local power generator
120 local energy feeder line
122 local secondary generation meter
124 local secondary generation meter
126 secondary utility power meter
128 interconnecting line
130 optional meter example
132 data network
134 computerized database and interface
136 outlines equipment owned by the power utility—prior art
138 outlines equipment owned by the power customer—prior art
140 outlines equipment with ownership by a third party—new
142 outlines equipment owned by the power customer—new
144 outlines equipment owned by the power utility or cooperative—new

### DRAWINGS

### Symbols Used

Circles marked as “GEN” such as local generators 114 and 118 are sources of generated power. The circle 100 marked as “power utility” is a power source yet can also as noted absorb locally generated power thus it is more than just a power source. The power utility can both provide power and receive locally generated power.

Octagons and pentagons are two types of symbols used to indicate power metering in the drawing. The octagonal symbol used as “utility meter” 104 is labeled “WH” for “Watt Hour” meter. This type of meter records over time the amount of power passing through the meter, power passing from the power utility to the customer incrementing the meter reading and power flowing in the opposite direction decrementing the meter reading with a net resultant reading of power utilized over time. The second symbols for meters are the pentagonal Watt Hour meters labeled as “WH” which are 122, 124, 126, 130. The pentagonal WH meters indicate that the function of measuring “Watt Hours” will be performed by the metering device measuring power flow through the device but that the meter measuring device may or may not average the readings over time at the meter as compared to the WH meter with the octagonal symbol 104. The WH meters indicated by the pentagons most effectively will communicate their instantaneous readings to logging systems where power flow over time is calculated and billing (invoicing the customer for monetary gain) is performed such as the computerized database and interface 134. Many configurations of various quantities of these meters can be used to perform the desired functions. These two types of watt-hour meters can be interchangeable in other embodiments, but are used in this embodiment to show a common system.

Rectangular symbols in the drawings 108, 110 indicate power loads or points in the systems that are the main consumers of the power. Labeled “power customer load” these are elements that consume power and the owner of the consumer power loads is billed for the power consumed by the loads.

Drum symbol 134 is used to indicate databases and algorithms which are used to obtain meter readings calculate power usage from the various sources, record meter readings over time, either report usages for billing the customer or initiate or complete the billing of customers for power used. Use of computers and communication technologies for these functions is commonplace in the art.

Broken lines with the pattern “dash dot dot dash” indicate prior art such as those enclosing elements of the drawings which are prior art in ownership such as power utility owned equipment 136 (first ownership entity), power customer owned equipment 138 (second ownership entity), power customer owned equipment 142 (second ownership entity).

Broken lines with the pattern “dash dot dash” indicate new elements such as those enclosing elements of the drawings which are claimed in the embodiment as novel by way of ownership by a third ownership entity 140, and combined ownership of the first and third ownership entities 144.

### DETAILED DESCRIPTION OF THE PREFERRED EMBODIMENT

In FIG. 1 a wide area power source 100 is an electrical power grid from a utility company in this embodiment, not illustrated power source 100 could also be a natural gas line, a thermal source such as thermal energy from a geothermal source or any measurable energy source in other embodiments.

An energy feeder line 102 connects the wide area power source 100 to a utility meter 104.

Equipment owned by a power utility company or cooperative 136; the utility meter 104 is used to measure the passing power over a period of time to a load in order to bill a user and obtain monetary income for the wide area power source 100 owner. Generally the wide area power source owner is a public utility company.

A local energy system 106 is a wiring system to pass energy between power sources and power loads.

Equipment owned by a power customer 138 in a conventional ownership configuration for local power generation; a power load 108 and a power load 110 are devices or systems, by which the power consumer consumes power. Power loads 108 and 110 are shown schematically and are not shown in detail but can be specific devices or aggregate systems such as light bulbs in an electrical system, the interior environment of a personal residence for a thermal system, or any other power consuming device or system.

A local power generator 114 and a local power generator 118 are devices or “systems” that generate power, generally with less capacity than the wide area power source 100. Local power generators 114 and 118 in this embodiment are electrical, in this embodiment local power generator 114 is a wind turbine and local power generator 118 is a photovoltaic system, in other embodiments 114 and 118 could be other devices such which generate energy in the form of electricity or compressed air, or a biomass system which generates power as electrical, thermal, or flammable gas energy or any other energy generation method with the overall system being adapted for us with such types of energies. Local power generators 114, and 118 are reasonably close in physical proximity to, but not necessarily in close physical proximity to the power loads 108 and 110. The local power generation equipment is generally but not always located on the power customer's property.

A local energy feeder line 116 communicates power generated by 114 to 106.

A local energy feeder line 120 communicates power generated by 118 to 106.

An extension of the local energy system 112 is any additional connection to local energy system 106. 112 may consist of any number of local generators similar to 114 and 118, any number of local power loads similar to 108 and 110, and additional feeds from wide area power systems similar to 100, via similar systems such as 102 and meters similar to 104.

The local power generators 114, 118 and any other generators added to an expanded system via 112 are considered to be on the “load side” of the utility meter 104.

A normal prior art power system as exemplified in FIG. 1 allows the wide area power source i.e. a utility company 100 to sell power to a customer with locally located loads 108, and 110. The wide area power source i.e. a utility company 100 invoices the customer for the amount of power i.e. kilowatt-hours consumed by the customer. Power generated locally i.e. by a wind turbine 114, and 118 is added to the system on the local energy system 106 by equipment owned by the power customer 138 in a prior art configuration.

During times when there is no power being generated locally all energy consumed is billed to the customer by the utility company. When power is generated locally then the power utilized from the utility is offset by the locally generated power from local generators 114, and 118, thus reducing the amount of monetary compensation for the use of the utility's power. Further the net amount of power generated locally is subtracted from the net amount of power supplied by the power utility (wide area power source 100). In the extreme scenario no power is being consumed locally by loads 108, or 110, local generators 114, or 118 are generating power locally, and the power (energy) generated locally is passing back to the wide area energy source 100 (the utility). In the United States and in other countries laws have been passed to allow the customer to generate power locally and sell this power back to the utility; these laws are often referred to as “Net Metering” laws. These net metering laws (net metering) usually allow the utility 100 to buy back the locally generated power at the same cost as that which the power is normally sold to the customer, which is usually the highest rate in the supply chain. If the amount of energy generated locally by local generators 114, and 118 is in excess of the amount provided to the customer by the utility 100 a lower rate is used to pay back the customer. i.e. when the utility sells energy at 33 cents per kilowatt hour to a customer, the utility buys back power from the customer within a billing period (usually a month) at 33 cents per kilowatt hour, however if the total (net) amount of energy generated locally over a billing period is greater than that provided by the utility then a lower buy back rate is used by the utility such as 8 cents per kilowatt hour. These prices are for example only and are based on the era in which this patent was written. Local power generation equipment is primarily, but not limited to, obtaining power from renewable energy sources such as wind and solar power. The easiest form of energy to generate power in is in the form of electricity, but other forms of power may be used as well.

FIG. 2a is a general schematic of the detailed embodiment of FIG. 2b. General elements, which are common to both FIG. 1 and FIG. 2b, are used here with the same reference numerals for clarity representing the common elements of each of the FIGS. 1, 2a, 2b, and 2c.

Equipment owned by a first entity the power utility 136; the wide area power source 100 is an electrical power grid from a utility company in this embodiment. The local energy system 106 is a wiring system to pass energy between power sources and power loads. Equipment owned by a second entity that is the power customer the local power customer 142; the power load 108 is a device or system that consumes energy.

Equipment with ownership by a third party 140; the local power generation equipment 114 is a device or “system” for local power generation; the local energy feeder line 116 communicates power generated by 114 to 106 via a local secondary generation meter 122. The extension of the local energy system 112 allows expansion of more loads similar to 108 and more generators similar to 114 and more secondary generation meters similar to 122.

The general operation of this embodiment and the primary novelty is the local power generator(s) 114 is (are) owned by a third party other than the power utility 100 and the utility customer 108. The third party 140 sells the power generated locally to the utility customer 108 preferably at a rate below the current utility's rate, measured over time, such as billing for monthly, or yearly averages. The third party will generally charge a lower rate to the utility customer 108 for local power generated in excess of that supplied from the utility 100, measured over time, such as billing for monthly averages. The local equipment 114 and 122 may also be leased to the utility customer. The local equipment 114 and 122 may also be sold to the utility customer over time, by the third party with monthly or periodic payments made as payments to the third party for the power generated. The payments from the utility customer to the third party may also be at a fixed rate similar to conventional financing.

FIG. 2b is similar in description to the prior art FIG. 1 with the addition of components to exemplify a functional embodiment. Equipment with ownership by the third party 140 contains the local power generation equipment 114 and 118, the local secondary generation meter 122 and a local generation meter 124 measure the locally generated power passing from 116 and 120 respectfully to 106; a secondary utility power meter 126 replicates the functions of utility meter 104 and intercepts the power circuit between 104 and 106 through an interconnecting line 128. Secondary meter 126 is useful in simulating the meter reading of 104 and making these readings available for calculation of net metering costs. Additional generators placed on to the local system via 106 (not illustrated) would have similar meters and circuit placement similar to 122 and 124. The local generation meters 122, 124 and any other local generation meters added with via extension of 106 (not illustrated) measure the amount of power added to the local energy system 106 over time. Optional meter 130 shows that metering similar to meter 126 could be added at other locations in the circuit to perform similar results by using other calculations which are well known in the field such as deducing the difference between power generated locally via 122 and 124 (or similar) and total load metering if a meter is placed such as 130. Those skilled in the art can perform many variations on metering locations without deviating from the claims and spirit of this patent.

A data network 132 occurs at three points in FIG. 2 indicating connections to a computer communications network in whatever form it may be available such as a wide area network (WAN), a local area network (LAN), or wireless connections to either a WAN or LAN via Wi-Fi (trademark) or Bluetooth (trademark) and further connection to internet connections over internet protocol (IP). Data network 132 can connect to any number of points as needed in the system to perform the business method. In FIG. 2b all network connections 132 are essentially connected or can pass data in a bidirectional or single direction manner between all devices attached to 132, such as meters 122, 124, 126, and other optional meters which are illustrated but shown in only one example placement as optional meter 130; computerized database and interface 134 is also connected to the data network 132. The computerized database and interface 134 is used to collect metering data via network 132, perform use calculations, and bill customers according to use of power. The billing performed by computer systems 134 is sent over the network 132 either directly to customers (not shown) or to credit card companies (not shown), to banking computer systems (not shown) or other methods (not shown but well known in the literature) to obtain payments of the metering bills. Manual reading of meters and billing can also be used but is not shown.

FIG. 2c is an embodiment identical to that of FIG. 2b with the ownership of equipment owned by the power utility 144 changed to include the local generation equipment 114 and 118, and metering equipment 122, 124, 126, and optional 130, and power interconnections 116, 120, and 106. In the event that the local power utility wishes to provide the local power generation and metering equipment to the utility customer on the customer's property in exchange for a lower power bill from the utility this embodiment also anticipates this. The utility may also wish to transfer ownership of the local generation equipment to the utility customer in the form of rent, lease, or any other form of alternate ownership. This embodiment shows that the ownership of the third party equipment 140 in FIG. 2b can be by the utility 144. Power utility 144 may also be a utility cooperative.

The secondary meter 126 may be used to allow reliable access to meter readings of the aggregate utility meter readings without physically reading the utility meter 104. The customer may receive two separate power bills resulting from the above description, or the third party may form an arrangement with the utility to consolidate both types of bills into one consolidated bill. Automatic reading of meters 122, 124, 126 and any additional meters similar in function, such as optional meter 130, is performed by connection to a computerized database and interface 134 via a network 132 which can track flow of locally generated and utility supplied power. This computerized database and interface 134 is used to automatically calculate billing information and communicate any or all of this information to billing services (not shown), which will provide the billing to the customers, preferably electronically. Manual reading of meters and manual billing of the customer can also be used. Other advantageous functions can be performed by the computerized database and interface 134. Advantageous functions such as determining when it would be better not to bill the customer for locally generated power such as when the aggregate power generated locally over the utility billing period is greater than power supplied by the utility. In such a case the utility does not usually buy back power at the same rate as it sells power and may buy back power at a lower rate than the rate charged by the local power generation equipment third party company. Thus, price protection is possible to minimize the costs to the customer of green power over conventional power. Other functions performed by the computerized database and interface 134 are keeping track of variable billing rates of the local power company and adjusting the cost of the locally generated power billing to keep a cost to the power customer at a percentage of the power company's charged rate. Other rate changes such as long term rate adjustments and time of day rate adjustments, such as higher rates during peak hours or for consumption above certain levels during peak hours or otherwise.

Multiple generation systems may be present on the load side of the utility meter as described and illustrated in FIG. 1, 2a, 2b, and FIG. 2c. These multiple generation systems may be of different types such as wind, solar, geomass, and etc. and each generating infrastructure may be owned by different parties which may bill separately or in previously mentioned consolidated power (energy) bills. These business arrangements enable more use of environmentally friendly “green power” systems than would otherwise be installed. This novel technology based business method provides a new type of revenue stream for investors and an opportunity for ordinary people and businesses to buy energy at lower rates and help the environment at the same time.

This invention may be implemented in a residential or commercial business environment.

A more minimal system, although not illustrated in the minimum form, would consist of at least one wide area power source 100 and an associated interconnect 102, power meter 104 and local energy system 106, and at least one local generator 114 and associated interconnection 116, at least one local load 108, at least one meter 122, a communications network 132 and a computerized billing system 134. The number of wide area power sources, local generators and loads can be expanded to any number of devices as represented by 112.

The primary purpose of the computerized database and interface 134, and the meters 122 and 124 is to enable the third party owner of the local power generation systems to efficiently obtain monetary gain from the owner or user of the energy loads on the local energy system; these functions can alternately be performed manually (not shown) but in many cases may be more costly.

Local power generating equipment 114, 118, is usually more expensive than a power consumer may be interested in investing in infrastructure such as the financial capital required to erect towers, obtain licensing and handle legal issues of erecting towers, service the electrical and mechanical systems to keep the local systems generating energy efficiently. By placing secondary metering (122, 124, 126, or other meters such as 130) on the local energy generation equipment to measure the locally generated power a third party 140 may enter into the business relationship such that the third party will construct or install power generation equipment 114, 118 (any number of local generators can be used, only one or two are shown for this embodiment) locally at or near the power customer's location. The third party (via the example 134) can then bill the energy customer a separate and preferably lower rate than the local utility for locally generated power. This use of described secondary metering enables this novel business arrangement, which would otherwise not exist and has not been utilized or published prior to this patent application. Further, the local power equipment can also be owned by the power utility 144, or a power cooperative acting as a power utility 144, to provide the power customer a lower power rate in exchange for the use of the customer's property to place local green energy generating equipment.

In some instances utilities and laws allow the local generation equipment to be located at different locations than the power consumer's location and still receive the use of net metering of the generated power, e.g. Colorado U.S.A. 2008. These laws enable the local generation equipment to be less obtrusive in neighborhoods, place the “local” generators in more advantageous locations for efficiency, aesthetic needs, or zoning regulations. These variations are considered within the scope of the invention as the alternate generation locations are acting as proxies for the local generation equipment placements.

Multiple third parties (third entities) can implement this invention simultaneously, particularly, but not limited to, single power customer systems, without deviating from scope and claims of the invention. Many names may be used to refer to third entities, such as “third party,” “service provider,” or other names, titles, and marks; these and other alternate names for entities performing the third entity functions are anticipated and do not deviate from the scope and claims of the invention or embodiments.

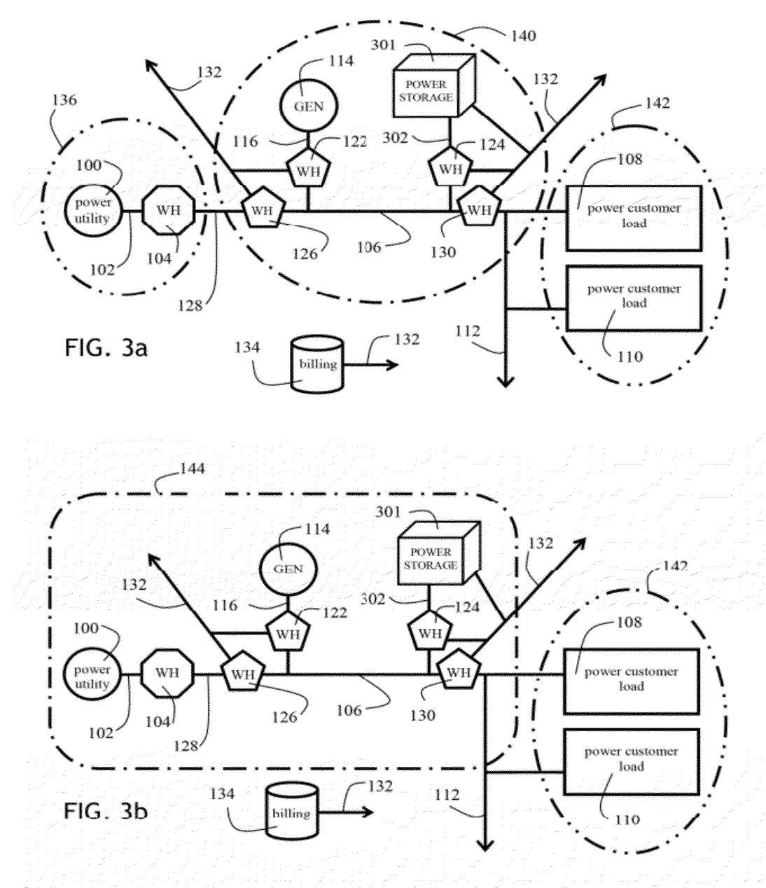

FIGS. 3a-b illustrate other exemplary aspects of the present invention. The method and system of FIGS. 3a-b includes, in addition to those features shown and described in FIGS. 2a-b, a power storage system 301 that is under remote operation, monitoring or control via a data network 132. The power storage system 301 stores power from the local power generator 114. The power stored on the power storage system 301 could be power generated in excess of demand from the power customer loads 108 and 110. The power stored on the power storage system 301 could also be used to store power generated from the local power generator 114, such as for example, when it is cheaper to utilize power from the power utility 100. The power storage system 301 provides for a computer monitored and released storage system connected to the local energy system 106 through meter 124. The power storage system 301 may include multiple means for storing and providing controlled release of the stored electricity. In one embodiment of the invention, the storage means includes an electric double-layer capacitor (EDLC) also known as super capacitor. Ideally, a super capacitor having a storage capacity greater than 1 farad is desirable. Storage and controlled release of electricity on the power storage system 301 may be monitored via a data network 132 as described above. Computer controlled storage and release of electricity stored on the power storage system 301 can be accomplished via the data network 132 from a remote location. In one aspect of the invention, remote monitoring of the power storage system 301 via the data network 132 allows the owner, the operator or the service provider of the local power generator 114 to control distribution of electricity from the power storage system 301 to a power grid via the data network 132 depending on whether it is advantageous to distribute the power to the grid or use the power locally at the power customer loads 108 and 110.

The detailed schematic of FIG. 3a illustrates a system similar to the system shown in FIG. 2c. Note specifically that in FIG. 3a the local power generator 114 is owned by a party other than the power customer, power utility or power cooperative. In other words, the local power generator 114 is owned by a party other than the party providing grid utility services to the power customer for supporting the power customer loads 108, 110. In the embodiment illustrated in FIG. 3a, the data network 132 may include a cloud-enabled network in addition to those network types described above. The power storage system 301 may include use of an uninterruptable power supply (UPS) that provides emergency, or otherwise useable power, to the power customer loads 108 and 110. This is particularly beneficial for times when little or no power is being generated by the local power generating system 114. In this instance, power can be drawn from the power storage system 301 to support all or part of the power customer loads 108 and 110. The systems may also be used to provide controlled metering of power to a demand from another power utility including a local power utility, a wide area power utility, or a COOP power utility.

FIG. 3b provides another embodiment to the system illustrated in FIG. 3a. In FIG. 3b, the local power storage system 301, the local power generator 114, and the power utility 100 are owned by the same entity. For example, this entity 144 could include a cooperative power utility, a local power utility, or a wide area power utility. Computer monitoring of power storage and usage is provided to a remote location, such as a location of the utility provider/owner, via the data network 132. Network enabled, computer monitoring of the power storage system 301 allows the power utility 144 to provide controlled metering of power generated from the local power generator 114 to power loads other than the customer power loads 108 and 110 where such metering is financially advantageous.

According to other aspects of the present invention, the system provides for a utility customer to have local power generation as previously described. Exemplary aspects of this include a utility provider forming a contractual relationship with a utility customer to provide local power generation equipment, such as a local power generator 114. The contractual relationship can take on various forms including a lease agreement, purchase agreement, rental agreement, use agreement, or other ownership arrangements. The contractual obligation may include other components such as a financial or maintenance obligation. These obligations may be discounted or reduced in exchange for placement of power generation equipment on the utility customer's premises. In one aspect of the invention, the utility customer enters into a contractual relationship with a power cooperative. As part of that relationship, the utility customer becomes a COOP member which requires the utility customer as a member to pay a membership fee to the power cooperative (COOP). As a member of the power cooperative, the utility customer receives utility service or power from the power cooperative. The utility customer has an obligation to the power cooperative for the power used by customer loads 108 and 110. A third party, such as a power utility unrelated to the power cooperative or the utility customer, which has possession of or ownership of power generation equipment forms a part of the contractual obligation. In one aspect of the invention, the third party, by contract, is permitted to place its power generation equipment on the premises of the utility customer or the coop member. A utility service obligation is formed between the COOP member and the third party utility service provider for charging a discounted utility service rate to the COOP member in exchange for the installation of the third party's power generating equipment on the premises of the utility customer/COOP member. The third party maintains and services the power generation equipment for the utility/COOP member for the utility customer/COOP member. Using a computer or other data processing system, a discounted utility service rate based on a net amount of power generated by the power generation equipment and used by the utility customer/COOP member is calculated. In a preferred form of the invention, the discounted utility service rate is less than the utility service cost provided by the power cooperative. The discounted utility service rate is charged to the COOP member as a discounted payment for the utility service obligation.

In another aspect of the invention, a method for a utility customer to have local power generation is provided. In this aspect of the invention, a power cooperative owns power generation equipment that can be used as local power generators 114. As is customarily known, the power cooperative includes a plurality of COOP members that receive a utility service from the power cooperative in exchange for membership in the power cooperative. As part of the membership in the power cooperative, the utility customer and the power cooperative form a contractual obligation. A component of the contractual obligation includes charging a discounted COOP utility rate to the utility customer in exchange for installation of the COOP's power generating equipment on the premises of the utility customer/COOP member. Another component of the contractual obligation includes a maintenance and service obligation for the power generation equipment provided by the power cooperative to the utility customer/COOP member. Using a computer or other data processing system, a discounted cooperative utility service rate is calculated for membership in the power cooperative based on a net amount of power generated by the power generation equipment and used by the utility customer/cooperative member. Using the billing process 134 enabled by the data network 132 the power cooperative monitors usage of power generated from the local power generating system 114 to calculate the discounted cooperative utility service rate which is then charged to the utility customer/COOP member in accordance with the contractual obligation between the cooperative and utility customer/COOP member.

In another aspect of the invention, a method for a utility customer to have local power generation is disclosed. As shown in FIG. 3b, the power utility 100 and local power generation equipment 114 may be owned by the same entity. In one aspect of the invention, the entity 144 is a power cooperative. A method for the utility customer/cooperative member to have local power generation is therefore provided. For placement of the local power generation equipment 114 on the premises of the utility/COOP member, a contractual relationship or obligation is formed between the cooperative and the utility customer. The utility customer becomes a member of the cooperative and as a member of the cooperative receives certain benefits which are defined by the contractual obligation between the cooperative member and the COOP. In one form of the contractual obligation, the cooperative installs their power generation of equipment 114 on the cooperative member premises, or local to the cooperative member's power loads 108 and 110. Also a part of the contractual obligation between the cooperative and cooperative member, the power cooperative defines terms for maintenance and servicing of the power generation equipment for and on behalf of the cooperative member. As previously discussed, membership in the cooperative requires the utility customer to pay a membership fee thereby becoming a member of the cooperative. The membership fee for membership in the power cooperative may be discounted or reduced based on a net amount of power generated by the local power generating system 114 and used by the cooperative member's loads 108 and 100. The power cooperative may use a computer or other data analysis system for calculating the discounted COOP membership fee based on the net amount of power generated by the local power generating system 114 and used by the COOP member. The discounted COOP membership fee is then charged to the COOP member as a discounted payment for the contractual obligation to the power cooperative.

The present invention further contemplates that in exchange for discounting or reducing the membership fee obligation to the cooperative, the cooperative may provide a contractual obligation where the expense associated with servicing and maintaining the local power generating system 114 is discounted or reduced based on the net amount of power generated by the power generating system 114 and used by the cooperative member. It is therefore further contemplated that a premises owner or utility customer may enter into a contractual relationship or obligation with an owner of local power generating equipment 114 owned by a power cooperative, or other power entity such as a wide area utility or local power utility, to have local power generating equipment 114 placed on the utility customer's premises for providing utility service to the power customer loads 108 and 110. In exchange for placement of the power generating equipment 114 on the premises of the utility customer, the owner of the power generating equipment may require certain obligations from the utility customer. Based on the net amount of power generated by the power generating equipment 114 and used by the utility customer, the owner of the power generation equipment may use this data to calculate a reduced or discounted obligation in return for placement of the power generating equipment on the premises the utility customer and use of the power generated. The owner of the power generation equipment may choose to reduce or discount certain elements of the contractual obligation. For example, the owner of the power generating equipment 114 may choose to discount or reduce the utility customer's financial obligation by choosing various components of the contractual obligation that could be reduced or discounted based on the net amount of power generated by the power generating equipment 114 and used by the utility customer. Components of the contractual obligation between the owner of the power generating equipment 114 and the utility customer that may receive discounts or be reduced include a maintenance or service component, a lease fee component, a user component, a membership component in an entity owning a part of or all of an ownership interest in the power generating equipment, a finance rate for purchase of the power generating equipment, finance terms for purchase of the power generating equipment, etc. Ownership of these terms need not be invested in a single entity. For example, the utility customer may enter into a contractual obligation with a power cooperative and as such remits payment for membership fees as a member of the power cooperative. A third unrelated party may have ownership of the power generation equipment 114 and provide use of the equipment on the cooperative member's premises. The third party and/or the power cooperative may provide maintenance and service of the power generating equipment. Alternatively, the power cooperative may provide maintenance and service of the power generation equipment 114 whereas the power generating equipment may be owned by a third party unrelated to the power cooperative. Similar arrangements may be contractually formed between other power providing entities such as a wide area power provider or a local power provider.

As illustrated in FIG. 3a, the contractual relationship may also be formed without regard to the power utility 100. In this aspect of the invention, a party having ownership of the power generating equipment 114 and power storage system 301 enters into a contractual relationship or obligation with the utility customer. The party having ownership of the power generating equipment 114 in the power storage system 301 could include a power cooperative, wide area power provider, or local power provider. This provider could be the same or different entity from the power utility 136. Components of the contractual obligation between the utility customer and the owner of the power generating equipment 114 and power storage system 301 could be altered in exchange for the net amount of power generated by the power generating equipment 114 and used by power customer loads 108 and 110. Similar to as set forth above, the entity 140 owning the power generating equipment and power storage system 301 could be a power cooperative. In this case, the utility customer becomes a member of the power cooperative by paying membership fees to the cooperative. These membership fees may be reduced or discounted based on the net amount of power being generated by the power generating equipment 114 and used by the utility customer/cooperative member.

In another aspect of the invention, the power cooperative or another entity may be responsible for servicing and maintaining the power generation equipment. Discounts may be provided to the utility customer for the fees associated with servicing and maintaining the power generating equipment in exchange for placement of the power generating equipment on the utility customer's premises. Additionally, the discounts or reduced maintenance and service fees charged to the utility customer may be discounted or reduced based on the net amount of power generated by the power generation equipment and ultimately used by the utility customer. The entity 140 owning the power generating equipment 114 and power storage source 301 need not be the same entity. For example, a third party may own the power storage system 301 whereas another party owns the power generating equipment 114. Additionally, the entity owning the power generation equipment 114 and power storage system 301 may be a power cooperative, a wide area power utility provider, or a local power utility provider.

Simplified examples have been used to best describe the invention in this embodiment for clarity. It is clear to those skilled in the arts that many different types of energy generation, metering, and computerized database, computerized billing systems, manual meter reading, manual billing systems and equipment ownership configurations can be utilized within the scope and claims of this invention.

Although the description above contains many specifications, these should not be construed as limiting the scope of the embodiments. Thus the scope of the embodiment should be determined by the appended claims and their legal equivalents, rather than by the examples given.

What is claimed:

1. A method for a utility customer to have local power generation comprising:
providing a COOP member and a power COOP owning power generation equipment;
forming a contractual obligation between the COOP member and the power COOP, the contractual obligation comprising:
a) installing the power generation equipment local to the COOP member;
b) the power COOP maintaining and servicing the power generation equipment for the COOP member;
c) calculating a discounted COOP membership fee for membership in the power COOP based on a net amount of power generated by the power generation equipment and used by the COOP member; and
d) charging the discounted COOP membership fee to the COOP member as a discounted payment for the contractual obligation.

2. The method of claim 1 wherein the contractual obligation is a lease for use or a lease for purchase.

3. The method of claim 1 further comprising storing power in a power storage system local to the COOP member.

4. The method of claim 3 further comprising computer network-enabled metering and monitoring of the power storage system from a remote location.

5. The method of claim 3 further comprising cloud network-enabled metering and monitoring of the power storage system from a remote location.

6. A method for a utility customer to have local power generation comprising:
providing a utility customer and an entity owning power generation equipment;
forming a contractual obligation between the utility customer and the entity, the contractual obligation comprising:
a) installing the power generation equipment local to the utility customer;
b) the entity maintaining and servicing the power generation equipment for the utility customer;
c) calculating a discounted equipment maintenance fee for servicing the power generation equipment based on a net amount of power generated by the power generation equipment and used by the utility customer; and
d) charging the discounted equipment maintenance fee to the utility customer as a discounted payment for the contractual obligation.

7. The method of claim 6 wherein the entity is a power COOP.

8. The method of claim 6 wherein the utility customer is a member of the power COOP.

9. A method for a utility customer to have local power generation comprising:
providing a power COOP receiving power from a WAP source, the power COOP comprising a plurality of COOP members receiving utility service from the power COOP;
the COOP member receiving utility service from the power COOP in exchange for membership in the power COOP;
providing a third party utility service provider owning power generation equipment;
forming a utility service obligation between a COOP member and the third party utility service provider for charging a discounted utility service rate to the COOP member in exchange for installation of third party's power generating equipment on a premises of the COOP member;
installing the third party's power generation equipment on the premises of the COOP member;
the third party maintaining and servicing the power generation equipment for the COOP member;
calculating the discounted utility service rate based on a net amount of power generated by the power generation equipment and used by the COOP member;
the discounted utility service rate being less than the utility service from the power COOP; and
charging the discounted utility service rate to the COOP member as a discounted payment for the utility service obligation.

10. A method for a utility customer to have local power generation comprising:
providing a utility provider owning power generation equipment, the utility provider comprising a plurality of utility customers receiving a utility service from the utility provider;
forming a contractual obligation between the a utility customer and the utility provider for charging a discounted equipment maintenance fee in exchange for installation of power generating equipment on a premises of the utility service;
installing the power generation equipment on the premises of the utility service;
the utility provider maintaining and servicing the power generation equipment for the utility customer;
calculating, by a processor, the discounted equipment maintenance fee based on a net amount of power generated by the power generation equipment and used by the utility customer; and
charging the discounted equipment maintenance fee to the utility customer in accordance with the contractual obligation.

11. The method of claim 10 wherein the utility provider is a power COOP and the utility customer is a member of the power COOP.

12. A method for a utility customer to have local power generation comprising:
providing a power COOP owning power generation equipment, the power COOP comprising a plurality of COOP members receiving a utility service from the power COOP, wherein the power COOP is not a WAP or local utility provider;
forming a utility service obligation between the a COOP member and the power COOP for charging a discounted COOP membership fee in exchange for installation of power generating equipment on a premises of the COOP member;
installing the power generation equipment on the premises of the COOP member;
the power COOP maintaining and servicing the power generation equipment for the COOP member;
calculating, by a processor, the discounted COOP membership fee for membership in the power COOP based on a net amount of power generated by the power generation equipment and used by the COOP member; and
charging the discounted COOP membership fee to the COOP member in accordance with the utility service obligation.

13. A method for a utility customer to have local power generation comprising:
providing a WAP provider receiving power from a WAP source, the WAP provider comprising a plurality of WAP customers receiving utility service from the WAP provider;
providing a third party utility service provider owning power generation equipment;
forming a utility service obligation between a WAP customer and the third party utility service provider for charging a discounted maintenance fee to the WAP customer in exchange for installation of the third party's power generating equipment on a premises of the WAP customer;
installing the third party's power generation equipment on the premises of the WAP customer;
the third party maintaining and servicing the power generation equipment for the WAP customer;
calculating the discounted maintenance fee for servicing the power generation equipment based on a net amount of power generated by the power generation equipment and used by the WAP customer; and
charging the discounted maintenance fee to the WAP customer as a discounted payment in accordance with the utility service obligation.
